(19) United States
(12) Patent Application Publication
(10) Pub. No.: US 2015/0346165 A1
(43) Pub. Date: Dec. 3, 2015

(54) Liquid Injection Panel For A Field-Mountable Gas Chromatograph

(71) Applicant: ABB Technology AG, Zurich (CH)

(72) Inventors: Michael Dean Roecker, Katy, TX (US); Robert A. Perry, Bartlesville, OK (US); Lodewyk M. De Jager, Broken Arrow, OK (US); James French, Bartlesville, OK (US)

(73) Assignee: ABB TECHNOLOGY AG, Zurich (CH)

(21) Appl. No.: 14/714,267

(22) Filed: May 16, 2015

Related U.S. Application Data
(60) Provisional application No. 62/003,216, filed on May 27, 2014.

(51) Int. Cl. G01N 30/20

(52) U.S. Cl. CPC G01N 30/20

(57) ABSTRACT

A sample injection system for a field-mountable gas chromatograph is described. The system has a sample injection chamber and a vaporization chamber. An analyzer valve is connected to both the vaporization chamber and the gas chromatograph to provide the liquid sample having a dew point above 60° C. and 15 psig to the gas chromatograph. The system and associated valves can be mounted on a panel that is connected to the gas chromatograph, the source of carrier gas and a calibration cylinder. Also described are the purging, sample collection and sample analysis techniques.

### 1. FIELD OF THE INVENTION

The present invention is directed toward gas chromatographs and, more particularly, toward field-mountable gas chromatographs.

### 2. DESCRIPTION OF THE PRIOR ART

Chromatography is the separation of a mixture of compounds (solutes) into separate components. This separation permits the composition of all or part of the mixture to be determined.

In gas chromatography, a gas chromatograph (commonly called a “GC”) is utilized to separate and determine the quantities of components of a gas mixture. A gas chromatograph performs these functions by taking a sample of the gas mixture to be analyzed and injecting it into a carrier gas stream, such as helium or hydrogen, which then carries the gas sample through one or more tubes (referred to as columns) that are packed with a very fine particulate material.

Each of the particles of this material are coated with a film from liquid that controls the rate at which the different components of the gas sample are absorbed and de-absorbed by the particulate material. This rate of absorption and de-absorption also varies relative to each of the different components. Because of this differing rate of absorption and de-absorption, certain gas molecules related to one type or component of gas will exit the column more quickly than some of the other components will exit the column.

This process of separation of components permits a detector located at the end of the column to quantify the amount of a particular component that is present in the mixture.

Conventional field-mountable gas chromatographs operate at a predetermined temperature and pressure for sample injection, for example 60° C. and 15 psig. The sample injection system described herein allows a conventional field-mountable gas chromatograph to analyze a liquid that has a dew point that is above the foregoing operating parameters.

### SUMMARY OF THE INVENTION

A sample injection system for a field-mountable gas chromatograph. The sample injection system has:

a sample injection valve to provide a predetermined amount of a sample of the liquid to be analyzed by the gas chromatograph, the liquid sample having a dew point above 60° C. and 15 psig;

a vaporization chamber connected to the sample injection valve to receive the predetermined amount of the liquid sample, the chamber using a carrier gas to dilute the predetermined amount of the liquid sample to a predetermined pressure to obtain the liquid sample having a dew point above 60° C. and 15 psig; and

an analyzer valve connected to the vaporization chamber and the gas chromatograph to provide the liquid sample having a dew point above 60° C. and 15 psig to the gas chromatograph.

A method for operating a sample injection system for a field-mountable gas chromatograph to analyze in the gas chromatograph a liquid sample having a dew point above 60° C. and 15 psig. The method is:

a. opening a vent valve in the system at the end of a predetermined period of time after the gas chromatograph has completed an analysis of a liquid sample having a dew point above 60° C. and 15 psig or after a beginning of a cycle for the gas chromatograph to analyze a new liquid sample having a dew point above 60° C. and 15 psig to vent a vaporization chamber in the system to atmospheric pressure;

b. closing the vent valve after the end of a predetermined period of vent valve open time; and

c. waiting a predetermined period of time after the vent valve is closed to open for a predetermined period of time a carrier valve to fill a vaporization chamber with a pure carrier gas and closing the carrier valve at the end of the predetermined open period of time for the carrier valve.

### DESCRIPTION OF THE DRAWING

FIG. 1 shows a perspective view of an exemplary gas chromatograph with a portion cut away to better show the interior features thereof.

FIG. 2 shows a front perspective view of the exemplary gas chromatograph of FIG. 1.

FIGS. 3 and 4 show the flow in the present sample injection system for purging, sample collection and analysis.

### DETAILED DESCRIPTION

It should be noted that in the following detailed description identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

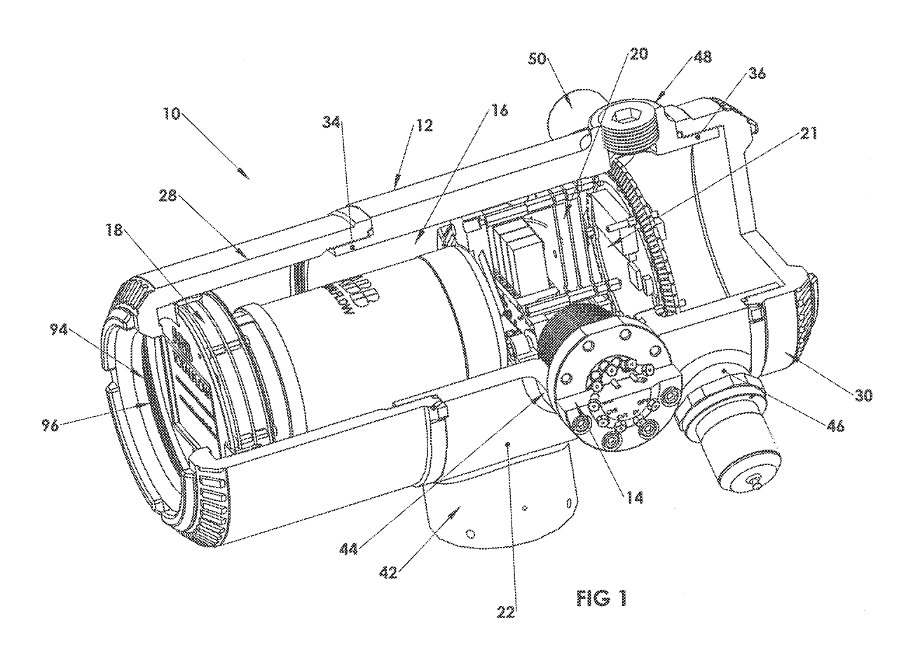

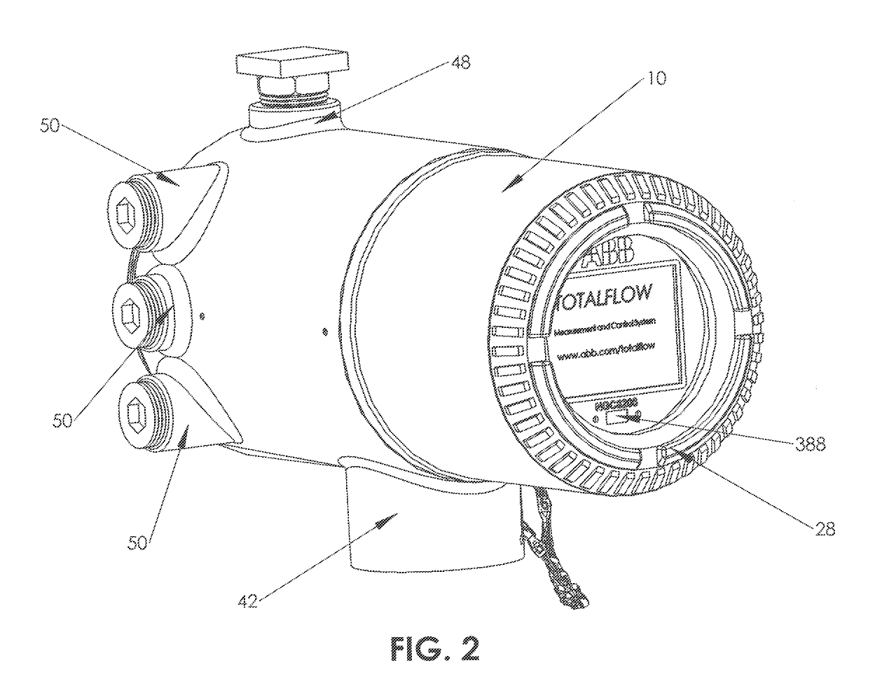

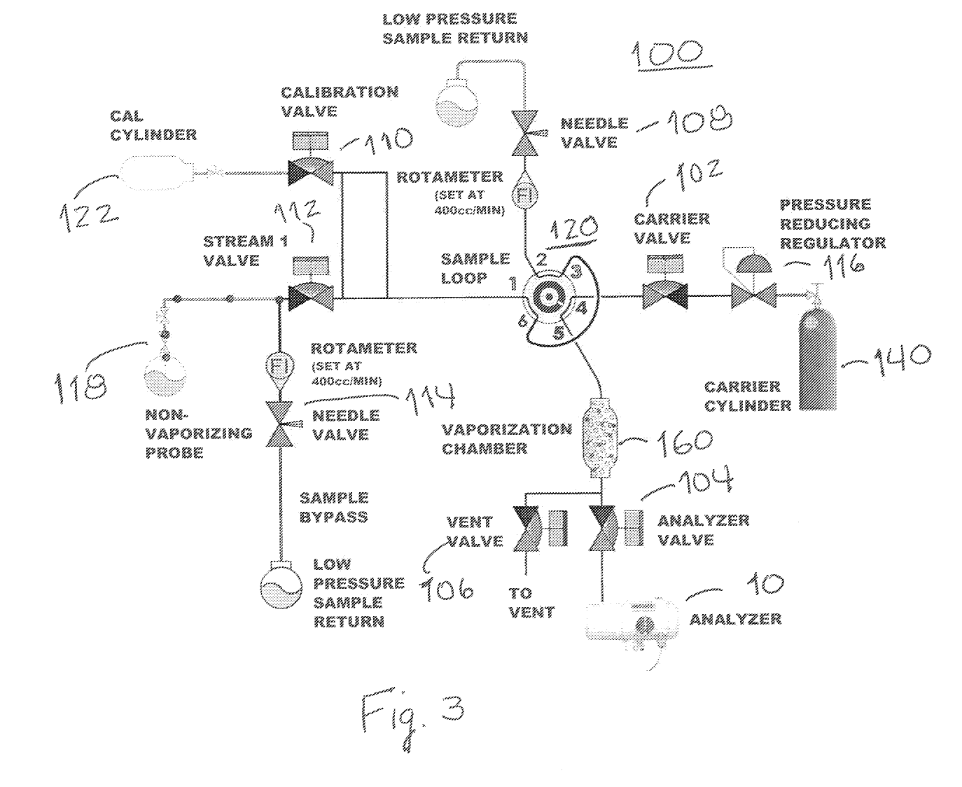

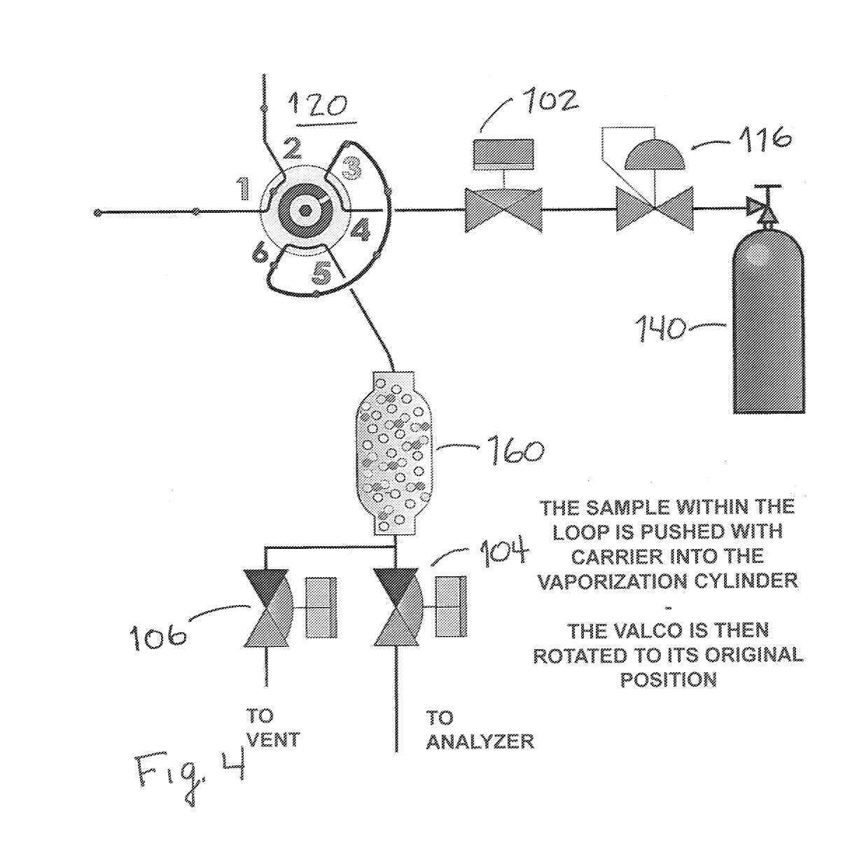

Referring now to FIGS. 1 and 2, there is shown without limitation an example of a gas chromatograph 10 for which the present sample injection system described below in connection with FIGS. 3 and 4 can be used to supply the samples to be analyzed by the gas chromatograph. For ease of description the gas chromatograph 10 is also referred to herein as either GC 10 or analyzer 10.

GC 10 is adapted for mounting in the field, proximate to a source of gas that is desired to be analyzed, such as natural gas and for use in harsh and explosive environments. More specifically, GC 10 is explosion-proof and has a NEMA 4X rating and can for example be the NGC 8206 GC available from ABB.

The paragraphs immediately below describe some of the details for the exemplary GC 10. Further details about GC 10 including how it is mounted in the field are described in U.S. Pat. No. 7,743,641 the disclosure of which is hereby incorporated herein by reference.

As is well known, GC 10 generally comprises a housing 12 enclosing a feed-through module 14, an analytical module 16, a main electronics assembly 18 having a main CPU 24, an analytical processor assembly 20 and a termination assembly 21.

The housing 12 includes a cylindrical main section having front and rear access openings closed by removable front and rear access covers 28, 30, respectively. The main section 22 has a unitary construction and is comprised of a cast metal, such as aluminum or steel. The main section 22 has threaded front and rear collars 34, 36 that define the front and rear access openings, respectively. An interior surface of the main section 22 defines an interior cavity (not shown in FIGS. 1 and 2. A main mount 42, a feed boss 44, first and second communication bosses 46, 48 and one or more conduit bosses 50 are joined to the main section 22 and extend outwardly therefrom.

As shown in FIG. 1, the rear access cover 30 is cylindrical and has anterior and posterior ends. The anterior end has an interior thread for mating with the exterior thread of the rear collar 36 so as to removably secure the rear access cover 30 to the main section 22 and close the rear access opening. The posterior end has a plurality of spaced-apart and circumferentially disposed ribs. The ribs help an operator establish a grip on the rear access cover 30 when rotating the rear access cover 30 to open or close the rear access opening.

The front access cover 28 is cylindrical and has anterior and posterior ends. The posterior end has an interior thread for mating with the exterior thread of the front collar 34 so as to removably secure the front access cover 28 to the main section 22 and close the front access opening. The anterior end has a plurality of spaced-apart ribs circumferentially disposed around a view opening 94. The ribs help an operator establish a grip on the front access cover 28 when rotating the front access cover 28 to open or close the front access opening. The view opening 94 is closed by a transparent shield panel 96 that provides shielding against radio frequency interference (RFI).

The conduit bosses 50 have threaded openings for securing conduits to the housing 12. Interior passages extend through the conduit bosses 50 and into the interior cavity. When the gas chromatograph 10 is mounted in the field, first and second conduits may be secured to first and second conduit bosses 50, wherein the first conduit runs power wiring into the interior cavity and the second conduit runs a communication line, such as an Ethernet cable, into the interior cavity. If a conduit boss 50 is not connected to a conduit, the conduit boss 50 is closed with an NPT plug.

Referring now to FIG. 3, there is shown a diagram of the present sample injection system 100 connected to the GC or analyzer 10. The sample injection system 100 allows a conventional field-mountable GC or analyzer 10 to analyze a liquid that has a dew point that is above the 60° C. and 15 psig operating parameters of GC 10.

As is well known, in order for GC 10 to analyze a liquid sample the sample must be diluted into a vapor that is injected into GC 10. The sample of the liquid to be analyzed is injected into GC 10 by a sample injection valve 120 which may be embodied by a valve available from Valco. A carrier gas such as Helium that does not interfere with the analysis of the sample is used to dilute the liquid sample into a vapor that can be injected into the GC 10 for analysis. The carrier gas is supplied from a cylinder 140 that is connected to the injection valve 120 by a high sensitivity pressure reducing regulator 116 and carrier valve 102 to valve 120.

A known amount of the liquid sample is released into a vaporization chamber 160 which is then filled by the injection valve 120 with the diluent carrier gas to a pressure which for this exemplary embodiment of system 100 is 30 psig. The diluted sample in chamber 160 is allowed to diffuse for a predetermined time period dependent on the cycle time per each GC application after which it is sent to the GC 10 for analysis.

As is also shown in FIG. 3 system 100 has in addition to valve 102 and regulator 116 six other air actuated valves 104 to 114 respectively controlled by GC 10, a non-vaporizing sample probe 118 and a calibration cylinder 122.

As shown in FIG. 3, valve 104 supplies the sample to be analyzed to GC 10, valve 106 is used to vent the chamber 160 during the purging process described below and valve 108 is connected between injection 120 and a low pressure sample return that functions to return the sample back into the system to which GC 10 is connected. Valve 112 is a stream valve connected between the non-vaporizing probe 118 that is to obtain the sample stream and the injection valve 120. Valve 114 is connected to the non-vaporizing probe 118 and a low pressure sample return to return the sample back into the system to which GC 10 is connected. Each of the low pressure sample returns includes a high pressure rotameter 124 to measure the flowrate of the sample to be returned that flows in the associated piping shown in FIG. 3. Valves 108 and 114 are adjusted as needed based on the sample flow to maintain proper flow for the sample.

As is well known in using GC 10 for analysis of a diluted to the point of vaporization of a liquid sample there are three processes that are associated with each analysis of a liquid sample. These processes are the purging to clear vaporization chamber 160 for the next analysis, the sample collection and the analysis by GC 10 of the diluted and thus vaporized liquid sample in chamber 160. The three processes are described below.

Purging—Vent Fill Cycle—these Steps are Repeated Three Times
1) Open Vent Valve 106 at 60 seconds either after the completion of a prior analysis or after the beginning of the cycle. Hold the valve open for 10 seconds and close. This allows the vaporization chamber 160 pressure to bleed to atmospheric pressure.
2) Wait for five (5) seconds after the valve 106 is closed, then open the carrier valve 102 for 20 seconds then close. This fills the cylinder with pure helium.
3) Wait for five (5) seconds after the cylinder supply valve is close and then repeat the above steps two more times etc. for a total of 3 Vent/Fill cycles.

### Sample Collection—Preparing the Diluted Sample

4) At 300 seconds, open carrier valve 102 and energize the stream injection valve 120 to simultaneously provide stream 1. As shown in FIG. 3, valve 120 has six positions identified by the numbers 1 to 6 that can be energized. For purging, sample collection and analysis the valve 120 is in the positions shown in FIG. 3 except for the brief time period for step 5 below where the positions are changed as shown in FIG. 4 to push the sample with carrier into the vaporization chamber 160.
5) At 360 seconds de-energize the stream 1 valve 120 leaving the carrier valve 102 on to allow the vaporization chamber 160 to fill completely.
6) At 390 seconds turn off the carrier valve 102. Diluted sample is ready for analyzer next cycle.

### Analysis of the Diluted Sample

7) At 0 to 20 seconds open the diluted sample to the analyzer valve 104. GC 10 pulls the sample for analysis.
8) Repeat all of the above steps if another sample is to be analyzed.

As can be appreciated system 100 can be embodied as a panel that is housed in a cabinet (not shown). The panel and cabinet have all of the valves such as valve 120 and the vaporization chamber 160 interconnected to each other as shown in FIGS. 3 and 4. The panel is connected as shown in those figures to the cal cylinder 122, carrier cylinder 140 and the analyzer 10.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A sample injection system for a field-mountable gas chromatograph comprising:
a sample injection valve to provide a predetermined amount of a sample of said liquid to be analyzed by said gas chromatograph, said liquid sample having a dew point above 60° C. and 15 psig;
a vaporization chamber connected to said sample injection valve to receive said predetermined amount of said liquid sample, said chamber using a carrier gas to dilute said predetermined amount of said liquid sample to a predetermined pressure to obtain said liquid sample having a dew point above 60° C. and 15 psig; and
an analyzer valve connected to said vaporization chamber and said gas chromatograph to provide said liquid sample having a dew point above 60° C. and 15 psig to said gas chromatograph.

2. The system of claim 1 further comprising:
a valve connected to said vaporization chamber to vent said vaporization chamber.

3. The system of claim 2 wherein said vent valve is opened at a predetermined time either after said gas chromatograph has completed an analysis of said liquid sample having a dew point above 60° C. and 15 psig or at the beginning of a cycle for said gas chromatograph to analyze said liquid sample and said vent valve is held open for a predetermined period of time.

4. The system of claim 1 comprising a carrier gas supply connected to provide through said sample injection valve carrier gas to said vaporization chamber.

5. The system of claim 4 further comprising a pressure reducing regulator and a carrier valve connected in series between said carrier gas supply and said sample injection valve.

6. The system of claim 1 further comprising a non-vaporizing probe to obtain said liquid sample for said sample injection valve.

7. The system of claim 6 further comprising a stream valve connected between said non-vaporizing probe and said sample injection valve, said stream valve when opened allowing said liquid sample obtained by said non-vaporizing probe to flow to said sample injection valve.

8. The system of claim 7 wherein said stream valve when opened causing said liquid sample to flow to said sample injection valve, said stream valve when closed allowing said liquid sample obtained by said non-vaporizing probe to flow through a rotameter.

9. The system of claim 1 wherein said system further comprises a panel on which are mounted at least said sample injection valve and said vaporization chamber.

10. A method for operating a sample injection system for a field-mountable gas chromatograph to analyze in said gas chromatograph a liquid sample having a dew point above 60° C. and 15 psig comprising the steps of:
a. opening a vent valve in said system at the end of a predetermined period of time after said gas chromatograph has completed an analysis of a liquid sample having a dew point above 60° C. and 15 psig or after a beginning of a cycle for said gas chromatograph to analyze a new liquid sample having a dew point above 60° C. and 15 psig to vent a vaporization chamber in said system to atmospheric pressure;
b. closing said vent valve after the end of a predetermined period of vent valve open time; and
c. waiting a predetermined period of time after said vent valve is closed to open for a predetermined period of time a carrier valve to fill a vaporization chamber with a pure carrier gas and closing said carrier valve at the end of said predetermined period of open time for said carrier valve.

11. The method of claim 10 wherein said method further includes the step of waiting for a predetermined period of time after said carrier valve is closed to repeat steps a, b and c for a predetermined number of times.

12. The method of claim 10 wherein said predetermined period of time to open said vent valve is sixty seconds, said predetermined period of vent valve open time is ten seconds, said predetermined waiting period of time is five seconds, and said predetermined period of said carrier valve open time is twenty seconds.

13. The method of claim 11 wherein said predetermined period of time for waiting after said carrier valve is closed to repeat steps a, b and c is five seconds and said predetermined number of times to repeat steps a, b and c is two times.

14. The method of claim 10 further comprising the steps of:
opening at a predetermined time after steps a, b and c are repeated for said predetermined number of times said carrier valve to provide carrier gas to said sample injection valve and simultaneously energize a stream valve connected between a non-vaporizing probe and said sample injection valve to provide said liquid sample having a dew point above 60° C. and 15 psig obtained by said non-vaporizing probe to flow to said sample injection valve;
closing only said stream valve after a predetermined period of time has elapsed from said opening of said stream valve; and
closing said carrier valve after a predetermined period of time has elapsed from said closing of said stream valve to thereby have in said vaporization chamber said liquid sample having a dew point above 60° C. and 15 psig in said vaporization chamber.

15. The method of claim 14 further comprising the step of opening a valve connected between said vaporization chamber and said gas chromatograph to provide to gas chromatograph from said vaporization chamber said liquid sample having a dew point above 60° C. and 15 psig.
